(19) United States
(12) Patent Application Publication
(10) Pub. No.: US 2020/0172019 A1
(43) Pub. Date: Jun. 4, 2020

(54) CAMERA FOR MOUNTING ON A VEHICLE AND VEHICLE WITH THE SAME

(71) Applicant: TRIPLE WIN TECHNOLOGY(SHENZHEN) CO.LTD., Shenzhen (CN)

(72) Inventors: SHENG-JIE DING, Shenzhen (CN); SHIN-WEN CHEN, Tu-Cheng (TW); LONG-FEI ZHANG, Shenzhen (CN); KUN LI, Shenzhen (CN); JING-WEI LI, Shenzhen (CN)

(21) Appl. No.: 16/375,461

(22) Filed: Apr. 4, 2019

(30) Foreign Application Priority Data
Dec. 4, 2018 (CN) 201811475123.5

(51) Int. Cl. B60R 11/04

(52) U.S. Cl. CPC B60R 11/04; F16M 13/02

(57) ABSTRACT

A camera for mounting on a vehicle includes a holder, a lens, and a polarizing film. The lens includes an optical lens body and an annular body. A part of the optical lens body is received in the holder and the other part of the optical lens body extends out of the holder. The annular body is disposed around an outer circumference of a portion of the optical lens body extending out of the holder. The polarizing film in the annular body faces the lens and weakens the effects of strong lights on images captured by the camera.

### FIELD

The subject matter of the present application generally relates to a camera for mounting on a vehicle.

### BACKGROUND

Different problems may occur to a camera mounted on a moving vehicle.

The existing camera cannot avoid glare on imaging. Recording the current situation when the vehicle is driven under strong lighting is difficult. It is also difficult for the driver of the vehicle to use images from the camera when reversing, during parking for example.

Therefore, there is room for improvement in the art.

### BRIEF DESCRIPTION OF THE DRAWINGS

Implementations of the present disclosure will now be described, by way of embodiments, with reference to the attached figures.

FIG. 1 is a perspective view of a camera mounted on a vehicle according to the present disclosure.

FIG. 2 is an exposed view of the camera of FIG. 1.

FIG. 3 is a cross-section view along line of FIG. 1.

FIG. 4 is a perspective view of a vehicle with the camera of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

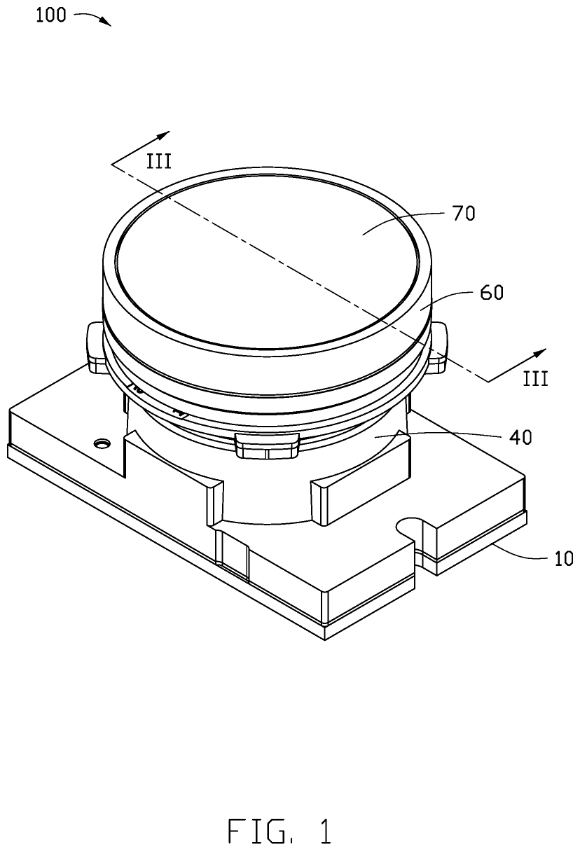

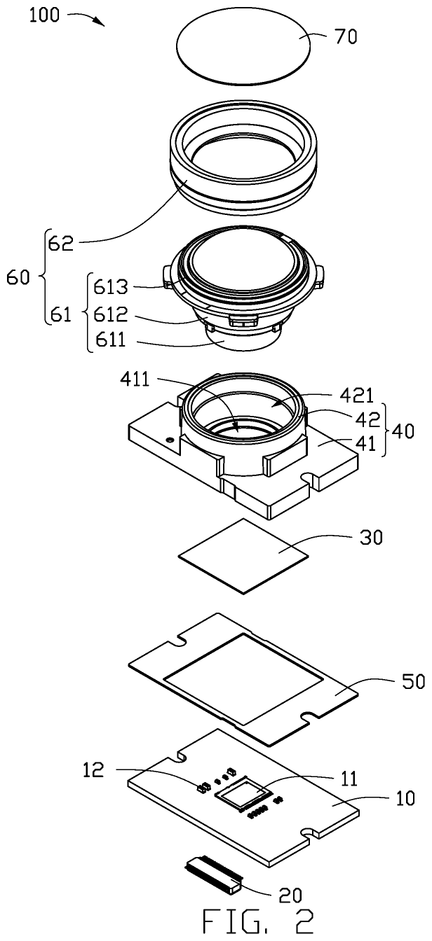

FIGS. 1-3 show a camera 100 for mounting on a vehicle. The camera 100 includes a printed circuit board 10, an optical filter 30, a holder 40, and a lens 60.

The printed circuit board 10 may be a flexible printed circuit board, a rigid printed circuit board, a rigid-flex printed circuit board, or the like. In at least one embodiment, the printed circuit board 10 is a rigid printed circuit board. A sensor 11 and a plurality of electronic components 12 are all mounted on the printed circuit board 10. The electronic components 12 may be a resistor, a capacitor, a diode, a triode, a relay, a live erasable programmable read-only memory (EEPROM), or other passive components.

The camera 100 further includes an electrical connector 20. The electrical connector 20 is mounted on the printed circuit board 10. The electrical connector 20 and the sensor 11 are on opposite surfaces of the printed circuit board 10. The electrical connector 20 is used to implement signal transmission between the camera 100 and other electronic components (not shown). The electrical connector 20 may be a connector or an edge connector (gold fingers).

The optical filter 30 is mounted in the holder 40. The optical filter 30 is configured to allow or not allow certain wavelengths of light to reach the camera 100. In at least one embodiment, the optical filter 30 is an infrared optical filter.

The holder 40 is mounted on the printed circuit board 10 by an adhesive layer 50. The holder 40 and the sensor 11 are on a same surface of the printed circuit board 10. The optical filter 30 faces the sensor 11. The holder 40 receives the sensor 11 and the electronic components 12, and mounts the lens 60.

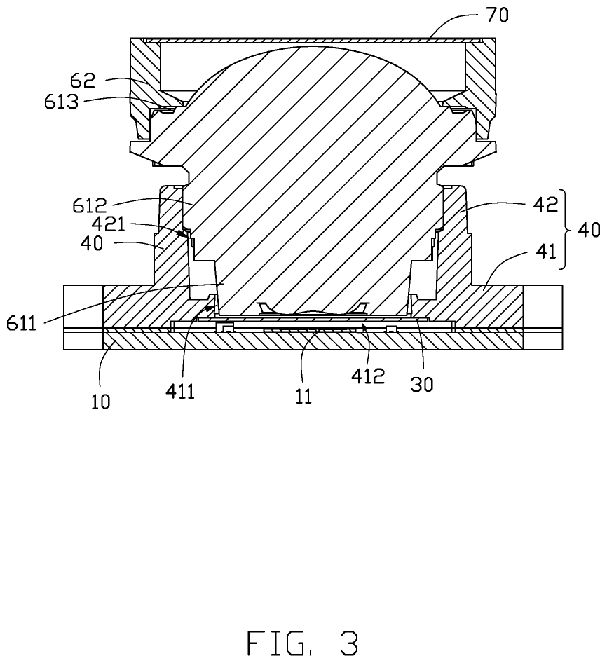

In at least one embodiment, the holder 40 includes a base 41 and a lens cone 42. The base 41 and the lens cone 42 are all rectangular. The base 41 is mounted on the printed circuit board 10. The lens cone 42 is mounted on the base 41 and away from the printed circuit board 10. The base 41 has a width that is greater than that of the lens cone 42. A first receiving hole 411 is defined in the base 41. The first receiving hole 411 receives the sensor 11 and the electronic components 12. A second receiving hole 421 is defined in the lens cone 42. The second receiving hole 421 is in air communication with the first receiving hole 411. A groove 412 is formed in the base 41 from a bottom portion of the first receiving hole 411 to the second receiving hole 421 as shown in FIG. 3. The groove 412 receives the optical filter 30.

The base 41 and the lens cone 42 are separately formed or can be integrally formed. In at least one embodiment, the base 41 and the lens cone 42 are integrally formed.

The base 41 and the lens cone 42 are made of metal or non-metal materials.

A part of the lens 60 is received in the second receiving hole 421 of the lens cone 42. The lens 60 includes an optical lens body 61 and an annular body 62. The optical lens body 61 includes a first lens portion 611, a second lens portion 612, and a third lens portion 613. The second lens portion 612 connects to the first lens portion 611 and the third lens portion 613. A diameter of the first lens portion is less than a diameter of the second lens portion and the diameter of the second lens portion is less than a diameter of the third lens portion. A part of the first lens portion 611 is received in the base 41 and the other part is received in the lens cone 42. The third lens portion 613 extends out of a side of the lens cone 42 away from the base 41. The first lens portion 611, the second lens portion 612, and the third lens portion 613 are separately formed or can be integrally formed. In at least one embodiment, the first lens portion 611, the second lens portion 612, and the third lens portion 613 are integrally formed.

The annular body 62 is disposed around an outer circumference of the third lens portion 613. The annular body 62 is made of metal or non-metal materials. In at least one embodiment, the annular body 62 is disposed around the outer circumference of a top end of the third lens portion 613 away from the second lens portion 612.

The camera 100 further includes a polarizing film 70. The polarizing film 70 is received in the annular body 62 and faces the first lens portion 611. The polarizing film 70 shields or allows penetration of light incident on the optical lens body 61. That is, the polarizing film 70 can transmit one of a longitudinal light and a lateral light and can shield the other one of the longitudinal light and the lateral light. The polarizing film 70 is circular, rectangular, or other shapes. In at least one embodiment, the polarizing film 70 is circular.

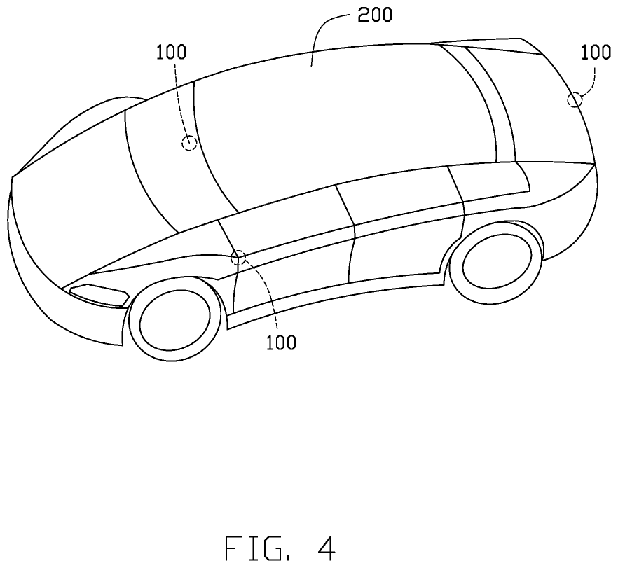

In FIG. 4, the camera 100 can be mounted to various vehicles 200, such as automobiles, ships, trains, and the like. In at least one embodiment, the camera 100 is applied to a car. The camera 100 can be a front-facing camera and a rear- or side-facing camera.

The polarizing film 70 weakens the effects of strong light on images captured by the camera 100 to ensure that the camera 100 functions as desired and clearly records the images during travel.

The embodiments shown and described above are only examples. Many details are often found in the art such as the other features of a camera and a vehicle with the car camera. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A camera for mounting on a vehicle comprising:
a holder;
a lens; wherein the lens comprises an optical lens body and an annular body, a part of the optical lens body is received in the holder, and the other part of the optical lens body extends out of the holder; the annular body is disposed around an outer circumference of a portion of the optical lens body extending out of the holder; and
a polarizing film, wherein the polarizing film is received in the annular body and faces the lens.

2. The camera of claim 1, wherein the camera further comprises a printed circuit board, a sensor is mounted on the printed circuit board, a plurality of electronic components is mounted on the printed circuit board, the holder is mounted on the printed circuit board, the sensor and the plurality of electronic components are received in the holder, and the sensor faces the lens.

3. The camera of claim 2, wherein the camera further comprises an electrical connector mounted on the printed circuit board, the electrical connector and the sensor are on two opposite surfaces of the printed circuit board.

4. The camera of claim 2, wherein the holder is mounted on the printed circuit board by an adhesive layer.

5. The camera of claim 2, wherein the holder comprises a base and a lens cone, the base is mounted on the printed circuit board, the lens cone is mounted on the base and away from the printed circuit board, a first receiving hole is defined in the base, the first receiving hole receives the sensor and the plurality of electronic components, a second receiving hole is defined in the lens cone and is in air communication with the first receiving hole, and the lens is received in the second receiving hole.

6. The camera of claim 5, wherein the base and the lens cone are separately formed or integrally formed.

7. The camera of claim 5, wherein the base and the lens cone are made of metal materials or non-metal materials.

8. The camera of claim 5, wherein the camera further comprises an optical filter, the base further comprises a groove formed therein from a bottom portion of the first receiving hole to the second receiving hole, the groove receives the optical filter.

9. The camera of claim 8, wherein the optical lens comprises a first lens portion, a second lens portion, and a third lens portion, the second lens portion connects to the first lens portion and the third lens portion; a diameter of the first lens portion is less than a diameter of the second lens portion and the diameter of the second lens portion is less than a diameter of the third lens portion; a part of the first lens portion is received in the base and the other part of the first lens portion is received in the lens cone; the third lens portion extends from a side of the lens cone away from the base; and the annular body is disposed around the outer circumference of the third lens portion.

10. The camera of claim 9, wherein the first lens portion, the second lens portion, and the third lens portion are separately formed or integrally formed; the annular body is made of at least one of a metal material and a non-metal material.

11. The camera of claim 9, wherein the polarizing film faces the first lens portion.

12. A vehicle comprising:
a camera for mounting on the vehicle, the camera comprising:
a holder;
a lens; wherein the lens comprises an optical lens body and an annular body, a part of the optical lens body is received in the holder, and the other part of the optical lens body extends out the holder; the annular body is disposed around an outer circumference of a portion of the optical lens body extending out of the holder; and
a polarizing film, wherein the polarizing film is received in the annular body and faces the lens.

13. The vehicle of claim 12, wherein the camera further comprises a printed circuit board, a sensor is mounted on the printed circuit board, a plurality of electronic components is mounted on the printed circuit board, the holder is mounted on the printed circuit board, the sensor and the plurality of electronic components are received in the holder, and the sensor faces the lens.

14. The vehicle of claim 13, wherein the camera further comprises an electrical connector mounted on the printed circuit board, the electrical connector and the sensor are on two opposite surfaces of the printed circuit board.

15. The vehicle of claim 13, wherein the holder is mounted on the printed circuit board by an adhesive layer.

16. The vehicle of claim 13, wherein the holder comprises a base and a lens cone, the base is mounted on the printed circuit board, the lens cone is mounted on the base and away from the printed circuit board, a first receiving hole is defined in the base, the first receiving hole receives the sensor and the plurality of electronic components, a second receiving hole is defined in the lens cone and is in air communication with the first receiving hole, and the lens is received in the second receiving hole.

17. The vehicle of claim 16, wherein the camera further comprises optical filter, the base further comprises a groove formed therein from a bottom portion of the first receiving hole to the second receiving hole, the groove receives the optical filter.

18. The vehicle of claim 17, wherein the optical lens comprises a first lens portion, a second lens portion, and a third lens portion, the second lens portion connects to the first lens portion and the third lens portion; a diameter of the first lens portion is less than a diameter of the second lens portion and the diameter of the second lens portion is less than a diameter of the third lens portion; a part of the first lens portion is received in the base and the other part of the first lens portion is received in the lens cone; the third lens portion extends from a side of the lens cone away from the base; and the annular body is disposed around the outer circumference of the third lens portion.

19. The vehicle of claim 18, wherein the first lens portion, the second lens portion, and the third lens portion are separately formed or integrally formed; the annular body is made of at least one of a metal material and a non-metal material.

20. The vehicle of claim 18, wherein the polarizing film faces the first lens portion.
